(19) United States
(12) Patent Application Publication
(10) Pub. No.: US 2008/0266666 A1
(43) Pub. Date: Oct. 30, 2008

(54) Optical Device for the Collection of Optical Signals

(76) Inventor: Philip Thomas Hughes, Plymouth (GB)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 11/659,855

(22) PCT Filed: Aug. 4, 2005
(86) PCT No.: PCT/GB2005/003074

§ 371 Date: Mar. 19, 2008

(30) Foreign Application Priority Data
Aug. 12, 2004 (GB) 0418002.2

(51) Int. Cl. G02B 27/10

(52) U.S. Cl. 359/618

(57) ABSTRACT

The invention provides an optical collection device (26) comprising a first stage optical concentrating device (34) and a second stage optical collection unit (40) having a housing (42) and an array of individual light collecting elements (46) in the housing. The array of light collecting elements provide, in combination, a light entrance and a light exit, each light collecting element having a light entrance aperture (62), a light exit aperture (64), and a light collecting region (44) extending between the entrance aperture and the exit aperture. The light collecting region provides a tapering light reflecting surface (66) arranged to direct light received at the entrance aperture towards the exit aperture. The invention also provides an optical receiver (20) comprising such an optical collection device and having at least one detecting element (24, 72, 74) arranged behind the light exit apertures to detect light transmitted by the optical collection unit.

### FIELD OF THE INVENTION

The present invention relates to an optical device for the collection of optical signals, and to a method for the same. In particular, in its preferred form at least, the present invention relates to a device for the collection and concentration of free-space optical signals received over a substantial angular range.

The invention, in conjunction with a suitable detector or detectors, may have application in transceivers of communications systems making use of free-space optical signals. However, the invention is not restricted to the visible region, and the principles of the invention may be employed with any wavelengths from the hard ultraviolet (from about 50 nm) upwards. In practice, the longest wavelengths that are likely to be used are in the cm-wave RF band (above 30-40 GHz). This being understood, in the rest of this document, the electromagnetic radiation that the invention is designed to transmit or collect will be referred to as “light”, or “optical”.

### BACKGROUND TO THE INVENTION

Devices to collect light for various purposes are well known.

However, the known devices suffer from a number of significant disadvantages. In particular, the prior art devices are generally incapable of efficiently collecting and concentrating optical signals from a wide range of angles simultaneously.

When an optical medium is used for commercial wireless communication purposes:—
1. As much signal light as possible needs to reach any optical detector(s),
2. Extraneous light ingress must be minimised,
3. To ensure that high data rates can be supported, optical temporal dispersion in the apparatus must be minimised, and the detector(s) must have as small a sensitive area as possible (to ensure a low device capacitance and hence fast response time),
4. In many practical applications, the need to align carefully transmitter and detector (either manually or automatically) should not be required.
5. The detectors need to be as cheap and spatially compact as possible.
6. Unlike the majority of optical systems, it should not, in principle, be necessary to image the incoming signals, merely to ensure that ultimately they all impinge on as small a spatial area as possible (a so-called “non-imaging system”).

The practical meaning of these requirements is that the device must:—
1. Have maximum sensitivity to signal light, i.e. collect as much light as possible. In practice, this means that the device must have a large input aperture, but with minimal overall dimensions.
2. Deliver light to simple low-cost, small aperture, fast electro-optical detectors.
3. Be sensitive to signal light impinging from as wide an angular range as possible.

Achieving simultaneously all these desirable features is difficult, if not impossible with conventional systems. For example, consider the following conventional optical systems as shown in FIG. 1.

### Converging Lens

A converging lens 10 (either thin spherical as illustrated in FIG. 1a below, or in Fresnel form) gathers light from a given direction impinging on its front aperture 12 and focuses it on to a small point F (in principle of zero dimension) on a curved image plane P (a distance f behind the lens for parallel incident rays) as shown in FIG. 1b. However, light rays from differing directions (e.g. from Δ [symbol] below the x-axis) are focussed onto separate points of the image plane, the deviation being Δz˜fΔ [symbol] . Clearly, to avoid multiple detectors, or having to move the detector, the detector dimensions must be less than Δz, and hence the angular sensitivity is restricted to a range of angles +/−tan⁻¹(Δz/f). [For Δz=1 mm, and f=100 mm, this means the angular sensitivity of a fixed detector is just +/−0.6 deg of arc.]

### Parabolic Mirror

A parabolic mirror 14 (illustrated in FIGS. 1c and 1d) has an analogous performance to a converging lens, and similar constraints apply to the angular range and sensitivity.

### Reflective Pipe

An internally reflecting cylindrical mirror (“light pipe”) 16 is good at accepting and transporting light from a wide-range of angles, but has no concentration effect. Rays exiting the pipe have substantially the same spatial and angular distribution as those entering it, as illustrated in FIG. 1e, which shows a vertical section through a light pipe.

### Conical Reflecting Surface

It might be imagined that, to improve the concentrating effect of a cylindrical light pipe, it is merely necessary to make the diameter of the light pipe become smaller with the distance along its axis, as in a conical or “horn” mirror 18 shown in FIG. 1f. Any light entering the larger aperture of the cone would then be successively “squeezed” down to exit the smaller aperture as desired. This is not quite the case in practice. Depending on the cone semi-angle (Ψ), more or less light actually gets reflected back out of the cone before reaching the smaller aperture—as illustrated in FIG. 1f.

To decrease the likelihood of rejection by reflection, the angle Ψ must be small. However, for a given sensitivity, this either makes the cone very long, or increases the size of the output aperture—thus decreasing the concentrating power of the geometry. Of course, in the limit Ψ→0, this cone becomes a non-concentrating pipe.

In summary, the converging lens and parabolic mirror optical systems are very efficient at collecting light. However, their angular sensitivity to light is very directional. Practical systems using these types of optics will require careful (manual or automatic) alignment in order to collect light impinging from a range of angles. In contrast, optical systems that are not particularly directionally sensitive such as the conical reflectors are also not particularly efficient at collecting light.

### SUMMARY OF THE INVENTION

The present invention seeks to overcome the above disadvantages of the prior art.

According to the present invention there is provided an optical collection device comprising a first stage optical concentrating device and a second stage optical collection unit having a housing and an array of individual light collecting elements in the housing, the array of light collecting elements providing, in combination, a light entrance and a light exit, each light collecting element having a light entrance aperture, a light exit aperture, and a light collecting region extending between the entrance aperture and the exit aperture, in which the light collecting region comprises a tapering light reflecting surface arranged to direct light received at the entrance aperture towards the exit aperture.

The optical concentrating device may consist of a single lens element or a number of lens elements.

The optical concentrating device may be situated in front of the housing for directing light onto the individual light collecting elements, such optical concentrating device comprising for example a spherical or a fresnel lens.

Preferably, the light entrance of the array of light collecting elements is substantially co-planar with the focal plane, ie the image plane, of the lens element or the plurality of lens elements.

The optical collection device may further include a filter cover provided over the optical concentrating device.

The effect of the optical concentrating device is to form an image in the focal plane thereof at the light entrance aperture of the optical collection unit. The optical collecting elements then sample the focussed light received from the optical concentrating device.

In a preferred form of the invention, the optical collection unit comprises a unitary housing formed with an array of ellipsoidal openings extending from the light entrance to the light exit, and each opening has a reflective wall surface providing the light reflecting surface. The reflective wall surface may be obtained by means of a reflective coating or the wall surface may be intrinsically reflecting as a result of being metal, e.g. brass, and machined to shape.

For example, the housing may be formed with a linear array of parallel openings, each of ellipsoidal form. The openings may be cavities within the housing or may contain an infill of a transparent dielectric material. In the latter instance, the refractive index of the dielectric material is advantageously selected to enhance the efficiency of light transmission.

Preferably, a plurality of the optical collection devices is juxtaposed to form an extended light receiving area. In the preferred form of the invention described below, each such optical collection device is in the form of a respective sector of a generally cylindrical or spherical solid.

In this instance, it is also preferred that a single light concentrating device overlap with several optical collection devices.

A feature of the invention, in the preferred embodiment described below, is that the light concentrating device comprises a concentrating element having a focal plane arranged to fall a short way in front of the light entrance aperture of each light collecting element. This ensures that the light from the light concentrating element enters the light collecting elements and is advantageous for the efficiency of the optical collection device.

The optical collection device of the present invention may be employed as an optical receiver by providing at least one detecting element arranged behind the light exit apertures of the individual light collecting elements so as to detect light transmitted by the optical collection device. For example, an array of detectors, each corresponding with a respective one of the array of light collecting elements, may be provided adjacent to the light exit apertures of the light collecting elements. In this instance, the array of detectors may effectively act as a continuous light detecting surface.

According to a further aspect of the present invention, therefore, there is provided an optical receiver comprising a first stage optical concentrating device and a second stage optical collection unit having a housing and an array of individual light collecting elements in the housing, the array of light collecting elements providing, in combination, a light entrance and a light exit, each light collecting element having a light entrance aperture, a light exit aperture, and a light collecting region extending between the entrance aperture and the exit aperture, in which the light collecting region comprises a tapering light reflecting surface arranged to direct light received at the entrance aperture towards the exit aperture, and the receiver further comprising at least one detecting element arranged behind the light exit apertures to detect light transmitted by the optical collection unit.

### BRIEF DESCRIPTION OF THE DRAWINGS

The invention will be described further, by way of example, with reference to the accompanying drawings, in which:

FIGS. 1a and 1b are schematic diagrams of a conventional optical system in the form of a converging lens;

FIGS. 1c and 1d are schematic diagrams of a conventional optical system in the form of a parabolic mirror;

FIG. 1e is a schematic diagram of a conventional optical system in the form of a reflective pipe;

FIG. 1f is a schematic diagram of a conventional optical system in the form of a conical reflecting surface;

FIG. 2 is a schematic sectional view through an optical receiver including an optical collection system according to the present invention;

FIG. 3 is a schematic sectional view through a respective optical collection device of the system shown in FIG. 2;

FIGS. 4a, 4b and 4c are respectively a side view, an end view and a plan view of an optical collection unit of the device of FIG. 3;

FIG. 5 is a detailed view of a respective light collecting element of the optical collection unit of FIG. 4 showing the way in which a light collecting element of the unit collects light; and

FIG. 6 is a diagram of an ellipse for explaining some of the parameters of the light collecting element of FIG. 5.

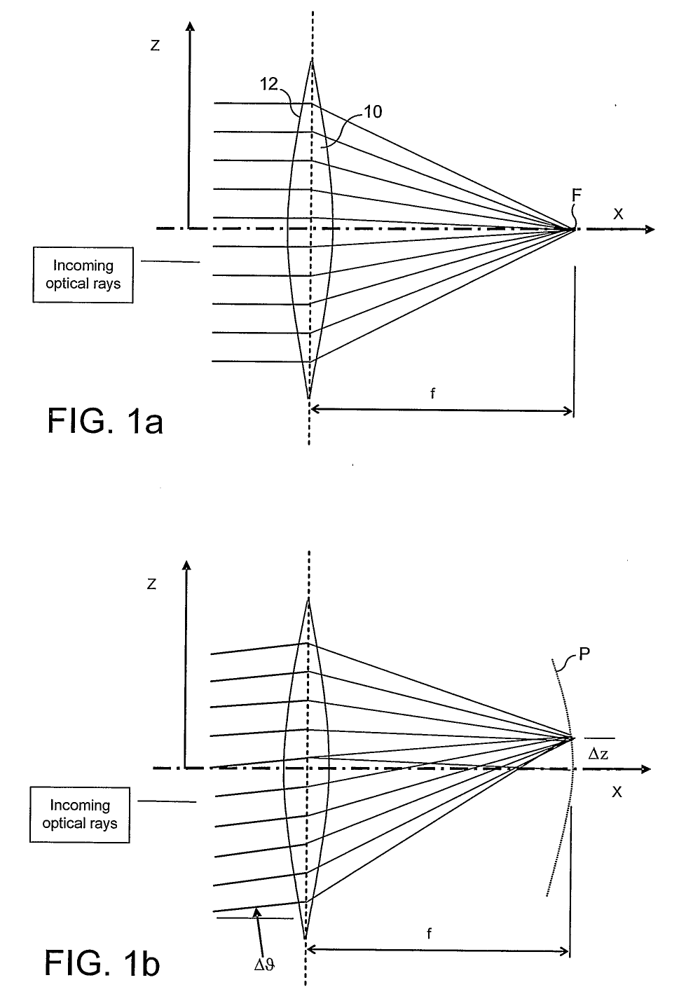

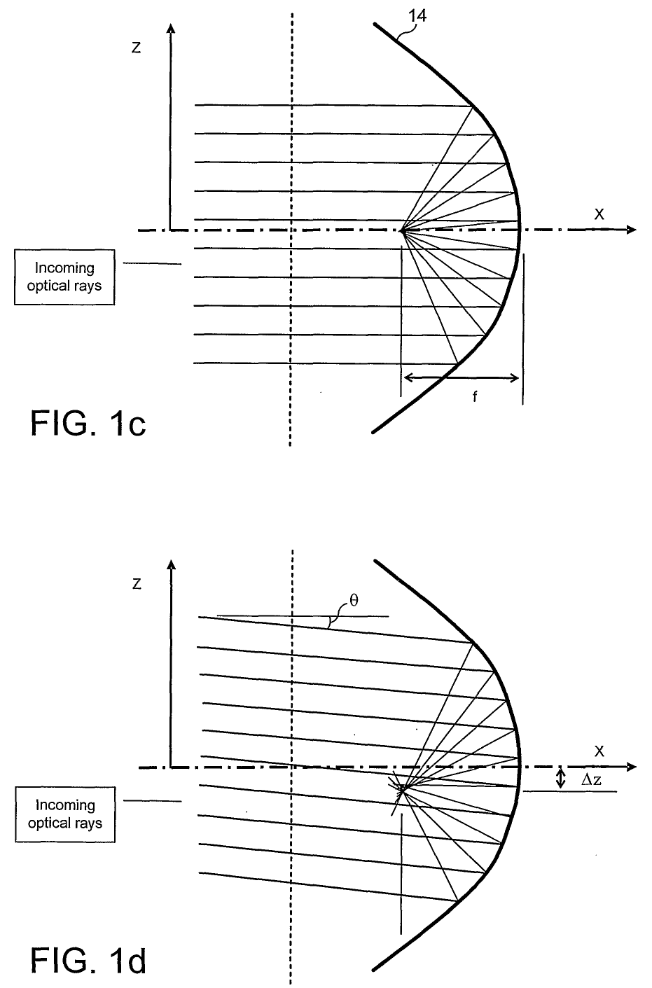

Referring initially to FIG. 2, a receiver including an optical collection system according to the present invention will be described. FIG. 2 shows a receiver 20 for optical signals comprising an optical collection system 22 and a detection system 24. The optical collection system 22 comprises a series of optical collection devices 26, in this instance five such devices, juxtaposed together to form an extended surface area 28 for receiving incident light. In the present example, each optical collection device 26 is, in section, in the shape of a sector of a circle and the five devices 26 fit together to describe a semicircle 30 in the sectional plane. More generally, the angle of each sector will be 360/(2N) where N is the number of optical collection devices 26.

All of the optical collection devices 26 are identical, and therefore only one of them will be described.

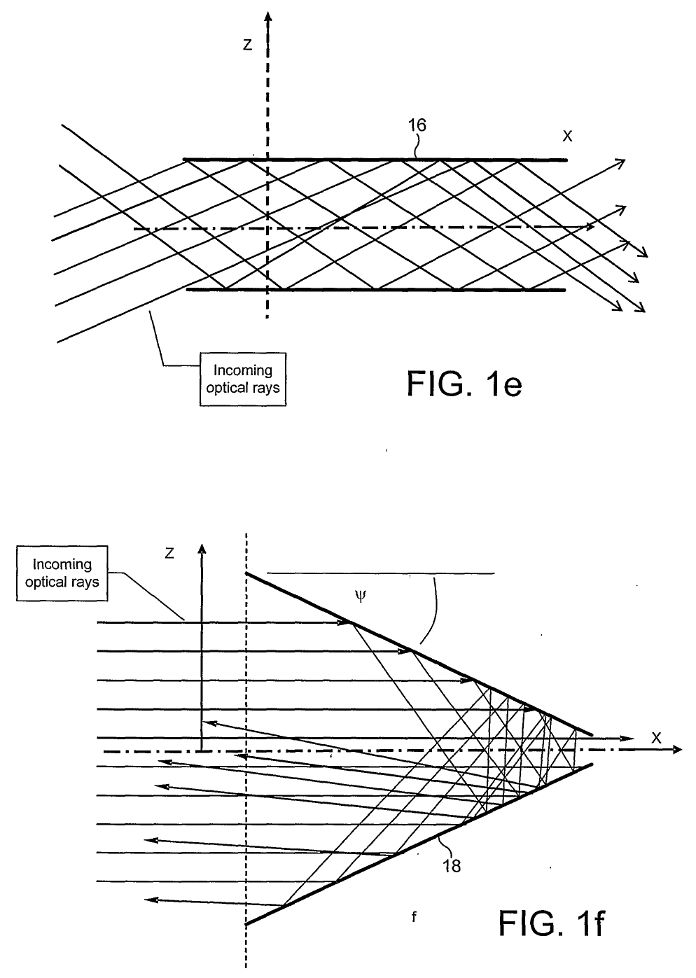

As shown in FIGS. 2 and 3, a respective optical collection device 26 has a front surface 32 for receiving incident light. A first stage optical concentrating device in the form of a light concentrating element 34 is provided at the incident light surface 32 and is protected by a filter cover 36. The light concentrating element 34 may take the form of a spherical lens or a circular fresnel lens, and serves to focus substantially parallel incident light rays received by the optical collection device 26 at a focal plane P near a front surface 38 of a second stage optical collection unit 40. The optical collection unit 40 comprises a unitary housing 42 formed with a plurality of openings 44 providing an array of individual light collecting elements 46.

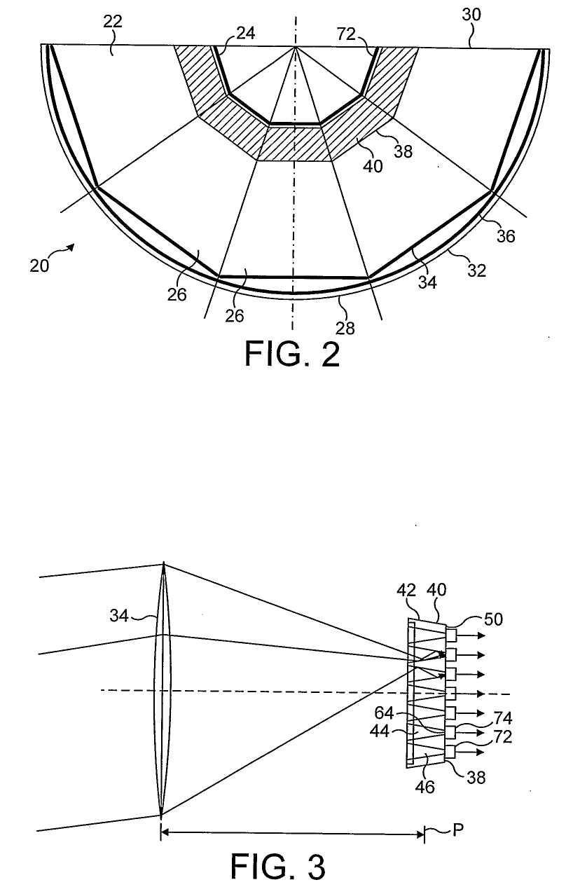

The housing 42 is best seen in FIGS. 4a to 4c, from which it is apparent that the housing 42 has a generally rectangular front surface 48, a generally rectangular rear surface 50, a square cross section 52 and converging side surfaces 54. This latter feature allows the individual optical collection devices 26 to be contiguous and in the form of sectors as mentioned. The front surface 48 has a central inset 56, and each opening 44 extends right the way through the housing 42 from the inset 56 to the rear surface 50. The inset 56 thus provides a light entrance 58 to the array of light collecting elements and the rear surface 50 thus provides a light exit 60.

The openings 44 of the light collecting elements 46 are arranged adjacent to one another and provide parallel passages for transmitting light through the housing 42. Each opening 44 has a light entrance aperture 62 at its end coinciding with the light entrance 58 and a light exit aperture 64 at its end coinciding with the light exit 60. The light collecting elements 46 in the present embodiment form a linear array across the housing 42, and the light entrance apertures 62 of the respective light collecting elements 46 are arranged closely adjacent to one another across the surface 56 to ensure that a substantial amount of the light incident on the light entrance 58 enters the light collecting elements 46. Further, the openings 44 and light entrance and exit apertures 62, 64 are shown circular here, but it will be appreciated that square or rectangular cross sections could be used to enhance the light collection efficiency of the front surface 48 of the light collecting unit 40.

The position of the focal plane P of the light concentrating lens 34 in relation to the entrance aperture 62 of each collecting element 46 determines the “spot size” of the light focussed on the entrance aperture 62. If this spot size is larger than the area of the entrance aperture 62 then, by definition, the peripheral light is lost. Hence to ensure maximum sensitivity to incident light, the focal plane P must be located such that the cross sectional area of the converging light rays from the lens 34 in the plane of intersection with the entrance aperture 62 must be less than the physical size of the entrance aperture 62.

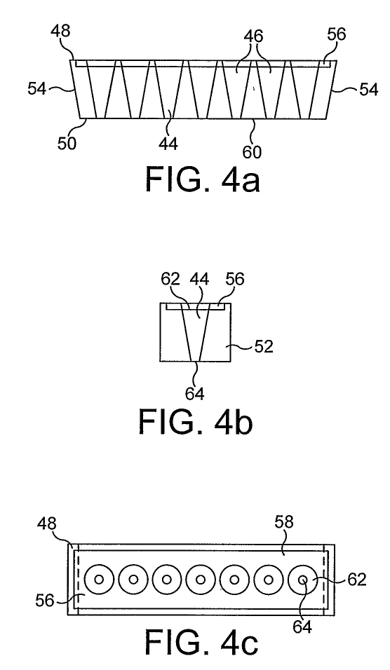

It can be seen that each opening 44 in the housing 42 has a tapering character in the direction extending from the light entrance 58 to the light exit 60. This tapering character is a significant feature of the invention and will be described further with reference to FIG. 5.

FIG. 5 shows two of the light collecting elements 46 in the housing 42. As illustrated, each opening 44 is of ellipsoidal form providing an ellipsoidal wall surface 66 defining the light collecting element 46. The wall surface 66 is coated with a reflective coating in gold, silver, copper or brass, to provide a mirror finish. Hence, light entering the opening 44 is reflected from the light reflecting surface 66 within the light collecting element 46. An infill 68 of a transparent dielectric material having a refractive index selected for enhancing efficiency is provided within the opening 44, and the inset 56 of the front surface 48 of the housing 42 allows the containment of such transparent in-fill material.

As stated, each opening 44 is ellipsoidal in form and has its wider front aperture 62 coinciding with the light entrance 58 and providing a light entrance aperture to the light collecting element 46, and its narrower rear aperture 64 coinciding with the light exit 60 of the housing 42 and providing a light exit aperture to the light collecting element 46. It is to be noted that the aperture 64 is set in from the apex of the ellipsoid by a predetermined amount to provide a sufficient area for light to exit the light collecting element 46. The aperture 64 is also positioned in front of the focus 70 at this end of the ellipsoid, in order to assist the reflection of light towards the exit aperture 64 rather than back towards the entrance aperture 62 thereby to enhance efficiency.

Accordingly, a substantial fraction of all the light entering the light collecting element 46 is reflected internally at the light reflecting surface 66 and exits at the light exit aperture 64. This feature is significant in that it ensures that light scattering within the light collecting element 46 is minimised and light is efficiently collected and transmitted through the light exit aperture 64 as described below.

Returning first, however, to FIGS. 2 and 3, the receiver 20 also includes the detector system 24, which is in the form of a respective detector array 72 provided for each optical detection device 26. Each such detector array 72 comprises a series of discrete diodes 74 mounted on the rear surface 50 of the housing 42 such that a respective diode 74 overlies the light exit aperture 64 of an associated one of the light collecting elements 46.

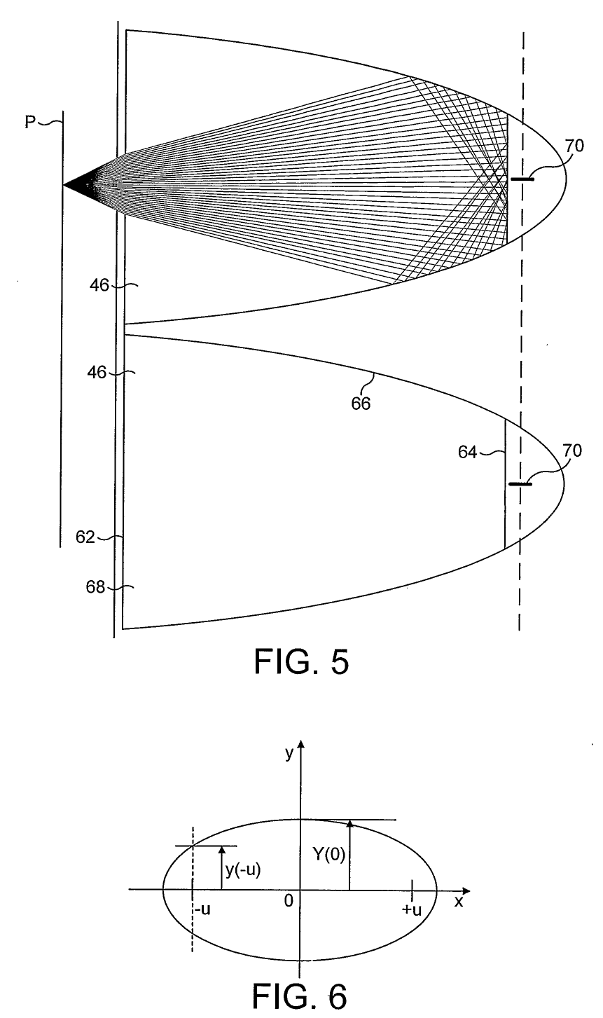

There are a number of design considerations involved in the production of a specific optical collection device 26, both in terms of the relationship of the entrance aperture 64 and the exit aperture 64 of each optical collection element 46 and in terms of the relative placement of the exit aperture 64 with the ellipsoid's focus 70, which may be explained with reference to FIG. 6.

Firstly, it is desirable for the entrance aperture 62 to be as large as possible relative to the exit aperture 64 and for the exit aperture 64 to have a much smaller area than entrance aperture 62, in order for the light collecting element 46 to have a maximum sensitivity to light, ie collect as much light as possible, and to be able to focus the light onto a small low-cost electro-optical detector. The size of the exit aperture 64 depends on its (x) positioning along the ellipsoid's major axis. Placing the exit aperture 64 nearer to the entrance aperture 62 will mean that the exit aperture 64 is larger, and placing the exit aperture 64 further away will mean that it is smaller.

Secondly, it is desirable for as much of the light passing through the entrance aperture 62 also to go through the exit aperture 64 for detection purposes. The position of the exit aperture 64 relative to the focus 70 influences this. If the exit aperture 64 position is further away from the entrance aperture 62 than is the focus 70 of the ellipsoid, then there is a high probability that light will be reflected between opposite wall portions of the ellipsoid and ultimately be reflected back out of the light collecting element 46 through the entrance aperture 62. This means that detection efficiency falls.

The optimum position for the exit aperture 64, to ensure maximum aperture area ratio with minimal reflection loss, is therefore on, or just in front of, the focus 70.

To understand how the aperture area ratio varies with the dimensions of the ellipsoid, consider the equation of an ellipse:—

(x/a)²+(y/b)²=1

where a and b are the maximum dimensions of the ellipse along the x and y axes respectively (see FIG. 6).

The positions of the ellipse foci can be shown to be at

x=+/−√(a²+b²)

Let us call this +/−u.

Now the area of the entrance aperture, assumed to be at x=0, is:_{—}

A₀=πb²

The area of the exit aperture, located at −x is:—

A₁=πb²(a²−x²)/a²

If the exit aperture is at x=−u (i.e. just on the focus), then:—

A₁=πb⁴/a²

Hence, the aperture ratio becomes:—

A₀/A₁=(a/b)²

Therefore, we can have, in principle, any aperture ratio, if the parameters for the ellipsoidal light collecting element 46 are chosen correctly. For very large ratios, a/b is very large, and this means that the element 46 is elongate. The practical limits are governed by parameters such as the overall size of the optical collection device 26, the focal length of the light concentrating lens 34 etc.

If it is required to have a longitudinal dimension of D₀ for the light entrance 58 represented by all the each light collecting elements 46 and a maximum longitudinal dimension of d for the light exit 60, and there are N elements 46, then the entrance diameter for the light entrance aperture 62 of each element 46 becomes

D₀/N=2b.

Thus D₀/N/d=a/b=2aN/D₀.

Hence, the length of each light collecting element 46 becomes

a(N)=½d(D₀/N)²

The significance of this is that

a(N)/a(1)=1/N²

which means that it is better in terms of size to divide the optical collection unit 40 up into more than one light collecting element 46, since the length of each element 46 decreases with the square of the number of elements 46 and this enhances the compactness of the overall system.

For example, if we have a condensing lens 34 of diameter 100.0 mm and focal length 100.0 mm, a detector diode 74 of 2.0 mm in diameter, and a horizontal angular range requirement for the whole system of 100 mrad, then the detector array 72 must be 100×0.1 mm=10 mm (2×b) in horizontal extent. If we were to use a single ellipsoidal collecting element 46, this would mean an entrance aperture 62 for the element of >=10 mm if the focal plane of the lens 34 is coincident with this aperture. We now require a diameter ratio of 10/2 for the entrance and exit apertures of this single ellipsoidal collecting element, from above, a/b=5, as b=5.0 mm, then a=25.0 mm. The ellipsoidal collecting element must then have a semi-major axis of 25 mm and an entrance diameter of 10.0 mm (corresponding to the minor axis).

Alternatively, if we were to use an optical unit 40 having a total of three ellipsoidal collecting elements 46 as described above, then the entrance aperture diameter of each would need to be 3.33 mm, and the lens position would need to be adjusted to give a spot diameter at the entrance aperture of <=3.33 mm. The exit aperture 64 needs to be 2.0 mm in diameter to suit the associated diode 74 and so, from above a/b is now 3.33/2.0=1.67. This means that a=1.67×3.33/2=2.78 mm. Thus by using three elements instead of one, we have made the optical unit 40 much less elongate (by a factor of 9=32), giving it a total effective length of 2.78 mm and total effective width of 10.0 mm.

It should be noted that this invention is applicable to an optical unit 40 of a size range from very large—several metres, down to sizes where the geometric ray treatment becomes invalid, usually about 10 wavelengths of the radiation being detected. In the case of infrared, where the wavelengths are ˜1000 nm, the minimum size of the invention is ˜10 micron.

With the described arrangement, substantially all the light incident on the front surface 28 of the receiver is transmitted through the lenses 34 and directed onto the light collecting elements 46. By virtue of the particular form of the light collecting elements 46, substantially all the light entering the light entrance apertures 62 is internally reflected within the light collecting elements 46 and is directed out of the light collecting elements 46 through the light exit apertures 64 onto the detection diodes 74.

The present invention, therefore, provides a highly efficient optical collection device and system and, in combination with the detection diodes a highly efficient optical receiver.

It will be apparent that a number of modifications are possible within the scope of the invention.

For example, the array of light collecting elements has been described as a linear array, but it could equally well be in the form of a grid or a matrix.

Further, the number and arrangement of the light collecting devices 26 could be varied.

The form of each individual light collecting element has been described as ellipsoidal, but it would also be possible instead to employ a shape of square or rectangular section with the walls of the opening converging towards the exit aperture. In this instance, the walls could be straight-sided or curved into a part-elliptical form.

In addition, although the walls of the openings have been described as having a reflective coating, they could instead be self-reflective.

What is claimed is:

1. An optical collection device comprising a first stage optical concentrating device and a second stage optical collection unit having a housing and an array of individual light collecting elements in the housing, the array of light collecting elements providing, in combination, a light entrance and a light exit, each light collecting element having a light entrance aperture, a light exit aperture, and a light collecting region extending between the entrance aperture and the exit aperture, in which the light collecting region provides a tapering light reflecting surface arranged to direct light received at the entrance aperture towards the exit aperture.

2. An optical collection device according to claim 1 in which the light reflecting surface is ellipsoidal.

3. An optical collection device according to claim 2 in which the light exit aperture is arranged in front of an adjacent focus of the ellipsoid.

4. An optical collection device according to any of claims 1 to 3 in which the light collecting region comprises a wall surface of an opening formed in the housing to extend between the entrance aperture and the exit aperture and in which the wall surface is reflective to provide the light reflective surface.

5. An optical collection device according to claim 4 in which the wall surface has one of a gold, silver, copper and brass coating to provide the light reflective surface.

6. An optical collection device according to claim 4 or 5 in which the opening contains a transparent infill.

7. An optical collection device according to any preceding claim in which the array of light collecting elements is a linear or grid array.

8. An optical collection device according to any preceding claim in which the housing comprises a unitary housing member formed with an array of parallel openings providing the array of light collecting elements.

9. An optical collection device according to any preceding claim in which the optical concentrating device comprises at least one lens element situated in front of the housing in order to direct light onto the light collecting elements.

10. An optical collection device according to any of claims 1 to 8 in which the light entrance is arranged substantially co-planar with the focal plane of the light concentrating device.

11. An optical collection device according to claim 9 or 10 in which the light concentrating element is one of a spherical lens and a fresnel lens.

12. An optical collection device according to any of claims 9 to 11 further comprising a filter cover over the light concentrating element.

13. An optical collection system comprising a plurality of the optical collection devices according to any preceding claim juxtaposed to form an extended light receiving area.

14. An optical collection system according to claim 13 in which the extended light receiving area lies on a generally cylindrical or spherical light receiving envelope.

15. An optical collection system according to claim 13 or 14 in which each optical collection device forms a respective sector of a generally cylindrical or spherical solid.

16. An optical receiver comprising an optical collection device according to any of claims 1 to 12 and at least one detecting element arranged behind the light exit apertures to detect light transmitted by the optical collection device.

17. An optical receiver according to claim 16 in which the at least one detecting element comprises an array of detectors, each corresponding with a respective one of the array of light collecting elements.

18. An optical receiver comprising an optical collection system according to any of claims 13 to 15 and at least one detecting element arranged respectively behind the light exit apertures of each light collection unit to detect light transmitted thereby.

19. An optical receiver comprising a first stage optical concentrating device and a second stage optical collection unit having a housing and an array of individual light collecting elements in the housing, the array of light collecting elements providing, in combination, a light entrance and a light exit, each light collecting element having a light entrance aperture, a light exit aperture, and a light collecting region extending between the entrance aperture and the exit aperture, in which the light collecting region provides a tapering light reflecting surface arranged to direct light received at the entrance aperture towards the exit aperture, and the receiver further having at least one detecting element arranged behind the light exit apertures to detect light transmitted by the optical collection unit.

20. A method for collecting light by means of an optical collection device including an array of light collecting elements, the method comprising directing light by means of an optical concentrating device onto the array of individual light collecting elements such that a substantial proportion of the light enters a light entrance aperture of each light collecting element, and reflecting light within a light collecting region of the light collecting element extending between the entrance aperture and an exit aperture thereof such that substantially all the light received at the entrance aperture is directed towards and emerges from the exit aperture.

21. An optical receiver for use in a communications system, comprising:
a first stage optical concentrating device;
a second stage optical collection unit having a unitary housing member formed with an array of openings providing an array of individual light collecting elements forming, in combination, a light entrance and a light exit, each light collecting element having a light entrance aperture, a light exit aperture, and a light collecting region extending between the entrance aperture and the exit aperture, in which the light collecting region comprises a tapering light reflecting surface arranged to direct light received at the entrance aperture towards the exit aperture; and
an array of detectors corresponding respectively with the array of light collecting elements and arranged behind the light exit apertures of the light collecting elements in order to detect light transmitted by the light collecting elements.

22. An optical receiver according to claim 21 in which the light reflecting surface is ellipsoidal.

23. An optical receiver according to claim 22 in which the light exit aperture is arranged in front of an adjacent focus of the ellipsoid.

24. An optical receiver according to claim 21 in which the light collecting region comprises a wall surface of an opening formed in the housing to extend between the entrance aperture and the exit aperture and in which the wall surface is reflective to provide the light reflective surface.

25. An optical receiver according to claim 24 in which the wall surface has one of a gold, silver, copper and brass coating to provide the light reflective surface.

26. An optical receiver according to claim 24 in which the opening contains a transparent infill.

27. An optical receiver according to claim 21 in which the array of light collecting elements is a linear or grid array.

28. An optical receiver according to claim 21 in which the optical concentrating device comprises at least one lens element situated in front of the housing in order to direct light onto the light collecting elements.

29. An optical receiver according to claim 21 in which the light entrance is arranged substantially co-planar with the focal plane of the light concentrating device.

30. An optical receiver according to claim 28 in which the light concentrating element is one of a spherical lens and a fresnel lens.

31. An optical receiver according to claim 28 further comprising a filter cover over the light concentrating element.

32. An optical receiving system comprising a plurality of the optical receivers according to any preceding claim juxtaposed to form an extended light receiving area.

33. An optical collection system according to claim 32 in which the extended light receiving area lies on a generally cylindrical or spherical light receiving envelope.

34. An optical collection system according to claim 32 in which each optical receiver forms a respective sector of a generally cylindrical or spherical solid.

35. A method for optical communications in which light is received by means of an optical receiver including a unitary housing formed with an array of openings providing light collecting elements, the method comprising directing light by means of an optical concentrating device onto the array of light collecting elements such that a substantial proportion of the light enters a light entrance aperture of each light collecting element, reflecting light within a tapering light collecting region of each light collecting element extending between the entrance aperture and an exit aperture thereof such that substantially all the light received at the entrance aperture is directed towards and emerges from the exit aperture; and detecting light emerging from the exit apertures by means of an array of light detecting elements corresponding respectively with the light collecting elements and arranged behind the light exit apertures.
